(19) United States
(12) Patent Application Publication
(10) Pub. No.: US 2022/0310117 A1
(43) Pub. Date: Sep. 29, 2022

(54) MAGNETIC DISK DEVICE AND METHOD

(71) Applicants: Kabushiki Kaisha Toshiba, Tokyo (JP); Toshiba Electronic Devices & Storage Corporation, Tokyo (JP)

(72) Inventor: Kenji Itou, Fujisawa Kanagawa (JP)

(21) Appl. No.: 17/465,684

(22) Filed: Sep. 2, 2021

(30) Foreign Application Priority Data
Mar. 23, 2021 (JP) 2021-048644

(51) Int. Cl. G11B 5/48; G11B 5/012; G11B 5/02

(52) U.S. Cl. CPC G11B 5/4873; G11B 5/4886; G11B 5/012; G11B 5/02

(57) ABSTRACT

According to one embodiment, a magnetic disk device includes a first actuator system, a second actuator system, a first controller, and a second controller. A first magnetic head is provided at a tip of the first actuator system. A second magnetic head is provided at a tip of the second actuator system. The first controller controls the first actuator system and relatively moves the first magnetic head with respect to the magnetic disk. The second controller controls the second actuator system and relatively moves the second magnetic head with respect to the magnetic disk. While the first magnetic head is retracted, the second controller acquires first information corresponding to input to the first actuator system and uses the first information to perform positioning control of the second magnetic head.

### INCORPORATION BY REFERENCE TO RELATED APPLICATION

This application is based upon and claims the benefit of priority from Japanese Patent Application No. 2021-048644, filed Mar. 23, 2021, the entire contents of which are incorporated herein by reference. Any and all applications for which a foreign or domestic priority claim is identified in the Application Data Sheet as filed with the present application are hereby incorporated by reference under 37 CFR 1.57.

### FIELD

Embodiments described herein relate generally to a magnetic disk device and a method.

### BACKGROUND

In the related art, a magnetic disk device capable of independently moving each of two or more magnetic heads by two or more actuator systems is known.

In the magnetic disk device, when a seek error occurs, the magnetic head may be retracted.

Examples of related art include U.S. Pat. Nos. 9,934,803, 9,911,442, and 6,493,172.

### DESCRIPTION OF THE DRAWINGS

FIG. 1 is a diagram showing an example of a configuration of a magnetic disk device related to a first embodiment.

FIG. 2 is a diagram illustrating a more specific configuration of an actuator system related to the first embodiment, and a positional relationship between the actuator system and the magnetic disk.

FIG. 3 is a control block diagram illustrating a retract operation of the magnetic disk device related to the first embodiment.

FIG. 4 is a schematic diagram illustrating an example of a relationship between a detection value of a drive voltage applied to a VCM in an actuator system performing a retract operation and a position error of a magnetic head positioned by the actuator system performing positioning control in the magnetic disk device related to the first embodiment.

FIG. 5 is a flowchart illustrating an example of an operation of the magnetic disk device related to the first embodiment.

FIG. 6 is a control block diagram illustrating a retract operation of a magnetic disk device related to a second embodiment.

FIG. 7 is a control block diagram illustrating the retract operation of the magnetic disk device related to a third embodiment.

FIG. 8 is a control block diagram illustrating the retract operation of the magnetic disk device related to a fourth embodiment.

### DETAILED DESCRIPTION

Embodiments provide a magnetic disk device and a method capable of preventing the influence of vibration generated when a magnetic head is retracted as much as possible.

In general, according to one embodiment, a magnetic disk device includes a magnetic disk, a first magnetic head and a second magnetic head, a first actuator system, a second actuator system, a first controller, and a second controller. The first magnetic head and the second magnetic head record data and reproduce data with respect to the magnetic disk. The first actuator system is provided with the first magnetic head. The second actuator system is provided with the second magnetic head. The first controller controls the first actuator system and relatively moves the first magnetic head with respect to the magnetic disk. The second controller controls the second actuator system and relatively moves the second magnetic head with respect to the magnetic disk. While the first magnetic head is retracted, the second controller acquires first information corresponding to input to the first actuator system and uses the first information to perform positioning control of the second magnetic head.

A magnetic disk device and a method related to embodiments are specifically described with reference to the accompanying drawings. In addition, the present disclosure is not limited to these embodiments.

### First Embodiment

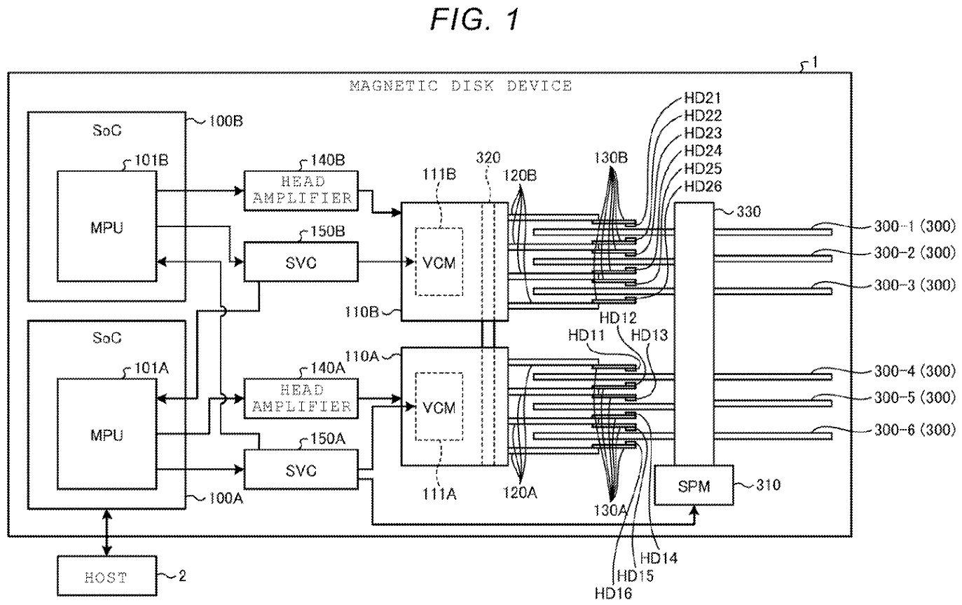

FIG. 1 is a diagram illustrating an example of a configuration of a magnetic disk device 1 related to a first embodiment. The magnetic disk device 1 can be connected to a host 2. The standard of the communication path between the magnetic disk device 1 and the host 2 is not limited to a specific standard. For example, Serial Attached SCSI (SAS) may be employed.

The host 2 corresponds to, for example, a processor, a personal computer, or a server. The magnetic disk device 1 can receive access commands (read command and write command) from the host 2.

The magnetic disk device 1 includes a plurality of magnetic disks 300 that rotate about a rotation shaft 330 of a spindle motor (SPM) 310. Here, for example, the magnetic disk device 1 includes six magnetic disks 300-1, 300-2, 300-3, 300-4, 300-5, and 300-6. The six magnetic disks 300-1, 300-2, 300-3, 300-4, 300-5, and 300-6 can be integrally rotated by the SPM 310.

Recording surfaces on which data can be recorded are formed on the front surfaces and rear surfaces of the six magnetic disks 300. In order to access 12 recording surfaces in total configured with the six magnetic disks 300, respectively, the magnetic disk device 1 includes 12 magnetic heads HD11 to HD16, and HD21 to HD26.

The magnetic head HD11 faces the front surface of the magnetic disk 300-4. The magnetic head HD12 faces the rear surface of the magnetic disk 300-4. The magnetic head HD13 faces the front surface of the magnetic disk 300-5. The magnetic head HD14 faces the rear surface of the magnetic disk 300-5. The magnetic head HD15 faces the front surface of the magnetic disk 300-6. The magnetic head HD16 faces the rear surface of the magnetic disk 300-6. The magnetic head HD21 faces the front surface of the magnetic disk 300-1. The magnetic head HD22 faces the rear surface of the magnetic disk 300-1. The magnetic head HD23 faces the front surface of the magnetic disk 300-2. The magnetic head HD24 faces the rear surface of the magnetic disk 300-2. The magnetic head HD25 faces the front surface of the magnetic disk 300-3. The magnetic head HD26 faces the rear surface of the magnetic disk 300-3.

Hereinafter, the 12 magnetic heads HD11 to HD16, and HD21 to HD26 may be collectively referred to as the magnetic heads HD. Each of the magnetic heads HD can access the recording surface provided on the front surface of the magnetic disk 300 that faces the magnetic head HD, that is, can record data and reproduce the data.

The magnetic disk device 1 includes two actuator systems 110 that can be independently driven. One of the two actuator systems 110 is referred to as the actuator system 110A, and the other of the two actuator systems 110 is referred to as the actuator system 110B. Hereinafter, “A” is added at the end of the reference numerals of elements that configure the actuator system 110A and elements relating to the actuator system 110A. In addition, “B” is added at the end of the reference numerals of elements that configure the actuator system 110B and elements relating to the actuator system 110B. In addition, when elements in the actuator systems 110A and 110B or elements relating to the actuator systems 110A and 110B are collectively referred to, the denotation of “A” or “B” at the ends of the reference numerals of elements may be omitted.

The actuator system 110A includes a voice coil motor (VCM) 111A, four actuator arms 120A, and six support members 130A. The six support members 130A support any one of the magnetic heads HD11 to HD16, respectively. The six support members 130 are connected to the tip of any of the four actuator arms 120A, respectively.

The actuator system 110B includes a voice coil motor (VCM) 111B, four actuator arms 120B, and six support members 130B. The six support members 130B support any one of the magnetic heads HD21 to HD26, respectively. The six support members 130B are connected to the tip of any of the four actuator arms 120B.

The two actuator systems 110 can rotate about a rotation shaft 320. The rotation shaft 320 is provided at a position parallel to the rotation shaft 330 and spaced from the rotation shaft 330. The VCM 111A can rotate the actuator system 110A about the rotation shaft 320 in a predetermined range. The VCM 111B can rotate the actuator system 110B about the rotation shaft 320 in a predetermined range. Accordingly, the actuator system 110A can relatively move the magnetic heads HD11 to HD16 with respect to the recording surfaces of the magnetic disks 300-4 to 300-6 in the radial direction. The actuator system 110B can relatively move the magnetic heads HD21 to HD26 with respect to the recording surfaces of the magnetic disks 300-1 to 300-3 in the radial direction.

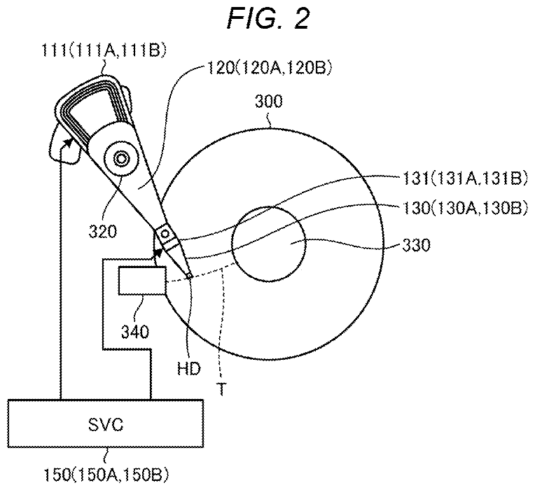

FIG. 2 is a diagram illustrating a more specific configuration of the actuator system 110 related to the first embodiment and a positional relationship between the actuator system 110 and the magnetic disk 300.

As illustrated in FIG. 2, an end portion of the actuator arm 120 is connected to the VCM 111. Also, the support member 130 is connected to an end portion on the opposite side of the VCM 111 of any one of the actuator arms 120. Also, a microactuator 131 is provided in the connection portion between the actuator arm 120 and the support member 130. The microactuator 131 is an actuator element such as a piezoelectric element.

The VCM 111 coarsely moves the actuator arm 120 parallel to the recording surface of the magnetic disk 300. Also, the microactuator 131 can finely move the support member 130 with respect to the recording surface of the magnetic disk 300. That is, the actuator system 110 is configured as a two-stage actuator that moves the magnetic head HD by the VCM 111 and the microactuator 131.

The actuator system 110 can relatively move the magnetic head HD along a locus T with respect to the recording surface of the magnetic disk 300 by the VCM 111 and the microactuator 131. A ramp load mechanism 340 for parking the magnetic head HD is provided on the locus T near the outer end of the magnetic disk 300.

The description refers back to FIG. 1.

The magnetic disk device 1 further includes System-on-a-Chip (SoC) 100A and SoC 100B, head amplifier 140A and amplifier 140B, and servo controller (SVC) 150A and SVC 150B.

The head amplifier 140A can amplify signals read by the magnetic heads HD11 to HD16 from the magnetic disks 300, output the signals, and supply the signals to the SoC 100A. In the SoC 100A, the signals supplied from the head amplifier 140A are demodulated into digital data by a read channel circuit (not illustrated).

In the head amplifier 140A, the signals corresponding to the digital data are supplied from the SoC 100A. The head amplifier 140A can amplify the signals supplied from the SoC 100A and supply the signals to the magnetic heads HD11 to HD16. The magnetic heads HD11 to HD16 that receive the signals record the signals on the recording surfaces of the magnetic disks 300.

The head amplifier 140B can amplify the signals read by the magnetic heads HD21 to HD26 from the magnetic disks 300, output the signals, and supply the signals to the SoC 100B. In the SoC 100B, the signals supplied from the head amplifier 140B are demodulated into digital data by a read channel circuit (not illustrated).

In addition, in the head amplifier 140B, the signals corresponding to the digital data are supplied from the SoC 100B. The head amplifier 140B can amplify the signals supplied from the SoC 100B and supply the signals to the magnetic heads HD21 to HD26. The magnetic heads HD21 to HD26 that receive the signals record the signals on the recording surfaces of the magnetic disks 300.

The SVC 150A drives the actuator system 110A based on an instruction from the SoC 100A. Specifically, the SVC 150A drives the actuator system 110A to position the magnetic head HD to be used among the magnetic heads HD11 to HD16 to a position instructed from the SoC 100A.

In addition, when a seek error occurs in the positioning control of the magnetic heads HD11 to HD16, the SVC 150A retracts the magnetic heads HD11 to HD16 in order to prevent the magnetic heads HD11 to HD16 from the erroneously colliding with the ramp load mechanism 340. The retracting of the magnetic head HD is an operation of withdrawing the magnetic head HD to the ramp load mechanism 340. Hereinafter, the operation of retracting the magnetic head HD may be also referred to as a retract operation.

In addition, the SVC 150A drives the SPM 310 based on the instruction from the SoC 100A. The SVC 150A drives the SPM 310 so that the rotation speed of the SPM 310 is constant at a target speed determined in advance.

The SVC 150B drives the actuator system 110B based on the instruction from the SoC 100B. Specifically, the SVC 150B drives the actuator system 110B to position the magnetic head HD to be used among the magnetic heads HD21 to HD26 to a position instructed from the SoC 100B.

In addition, when a seek error occurs in the positioning control of the magnetic heads HD21 to HD26, the SVC 150B retracts the magnetic heads HD21 to HD26 in order to prevent the magnetic heads HD21 to HD26 from erroneously colliding with the ramp load mechanism 340.

The SoC 100A is connected to the host 2. The SoC 100A interprets the access command from the host 2 and controls an operation based on the interpretation result, for example, controls the access to the magnetic disk 300.

The SoC 100A includes a Micro-Processing Unit (MPU) 101A. The MPU 101A operates according to a firmware program. The firmware program is stored in a predetermined nonvolatile storage area. The predetermined nonvolatile storage area may be the magnetic disk 300 or may be a Read Only Memory (ROM) (not illustrated).

The MPU 101A controls an operation of the entire magnetic disk device 1 together with the MPU 101B provided in the SoC 100B. For example, the MPU 101A controls an access to the magnetic disks 300 by using the magnetic heads HD11 to HD16 via the head amplifier 140A. In addition, the MPU 101A instructs rotation control of the SPM 310 with respect to the SVC 150A or controls the loading or unloading of the actuator system 110A via the SVC 150A.

In the positioning control, the MPU 101A calculates an instruction value of a drive voltage of the microactuator 131A and an instruction value of a drive voltage of the VCM 111A for causing the positions of the magnetic heads HD11 to HD16 to follow target positions pos_target, by using position signals pos read by the magnetic heads HD11 to HD16 from the servo information formed on the recording surface of the magnetic disk 300 as the feedback input, and transmits the obtained instruction values to the SVC 150A. The SVC 150A applies the voltage in accordance with the instruction value of the drive voltage of the microactuator 131A to the microactuator 131A and applies the voltage in accordance with the instruction value of the drive voltage of the VCM 111A to the VCM 111A. Accordingly, the magnetic heads HD11 to HD16 are positioned at the target positions pos_target.

The SoC 100B includes the MPU 101B. The MPU 101B operates according to the firmware program. The firmware program is stored in a predetermined nonvolatile storage area. The predetermined nonvolatile storage area may be the magnetic disk 300 or may be a ROM (not illustrated).

The MPU 101B controls an operation of the entire magnetic disk device 1 together with the MPU 101A provided in the SoC 100A. For example, the MPU 101B controls the access to the magnetic disks 300 by using the magnetic heads HD21 to HD26 via the head amplifier 140B. In addition, the MPU 101B controls the loading or unloading of the actuator system 110B via the SVC 150B.

In addition, in the positioning control, the MPU 101B calculates the instruction value of the drive voltage of the microactuator 131B and the instruction value of the drive voltage of the VCM 111B for causing the positions of the magnetic heads HD21 to HD26 to follow the target positions pos_target, by using the position signal pos read by the magnetic heads HD21 to HD26 from the servo information formed on the recording surface of the magnetic disks 300 as the feedback input, and transmits the obtained instruction values to the SVC 150B. The SVC 150B applies the voltage in accordance with the instruction value of the drive voltage of the microactuator 131B to the microactuator 131B and applies the voltage in accordance with the instruction value of the drive voltage of the VCM 111B to the VCM 111A. Accordingly, the magnetic heads HD21 to HD26 are positioned at the target positions pos_target.

In addition, the instruction value of the drive voltage of the microactuator 131 input from the MPU 101 to the SVC 150 and the instruction value of the drive voltage of the VCM 111 are examples of second information.

Subsequently, a retract operation is described. If the seek error occurs, the MPU 101 cannot recognize the current position of the magnetic head HD. If the positioning control is forcibly executed in such a state, the magnetic head HD collides with the ramp load mechanism 340, and the magnetic head HD may be damaged. Accordingly, the magnetic disk device 1 performs a retract operation when the seek error occurs. Accordingly, together with safely moving the magnetic head HD to the ramp load mechanism 340, the recognition of the position of the magnetic head HD is initialized.

If the seek error occurs during the positioning control, the MPU 101 instructs the SVC 150 controlled by itself among the SVCs 150A and 150B, to start the control of the retract operation. If an instruction of starting the control of the retract operation is received, the SVC 150 starts the control of the retract operation and then continues the control of the retract operation without the MPU 101 intervening the control until the retract operation is completed.

In the retract operation, the SVC 150 applies the voltage in a rectangular wave shape to the VCM 111. That is, the SVC 150 controls ON and OFF states of the drive voltage of the VCM 111. The SVC 150 detects Back Electro Magnetic Force (BEMF) of the VCM 111 during the period when the drive voltage of the VCM 111 is in the OFF state. The SVC 150 uses the detection value of the BEMF as the feedback input to move the magnetic head HD so that the movement speed of the magnetic head HD maintains the constant speed. Accordingly, the SVC 150 can retract the magnetic head HD at a safe speed.

In the retract operation, since the waveform of the drive voltage applied to the VCM 111 has a rectangular wave shape, vibration occurs in the VCM 111 performing the retract operation. Accordingly, if the retract operation starts in one actuator system 110 of the actuator systems 110A and 110B, the vibration occurring in the VCM 111 of the one actuator system 110 may propagate to the other actuator system 110 via the rotation shaft 320, or may deteriorate the positioning accuracy of the magnetic head HD in the other actuator system 110.

In the first embodiment, while the retract operation is performed in one actuator system 110 among the actuator systems 110A and 110B, the magnetic disk device 1 performs positioning control in the other actuator system 110 among the actuator systems 110A and 110B, by using the information corresponding to the input to the one actuator system 110 as the feed forward input. Accordingly, the influence of the vibration occurring in the retract operation of the one actuator system 110 among the actuator systems 110A and 110B on the positioning control of the other actuator system 110 among the actuator systems 110A and 110B is prevented.

Here, the input to the actuator system 110 is specifically a value of the voltage applied to the VCM 111. The information corresponding to the input to the actuator system 110 is detected by the SVC 150 according to the first embodiment and is the detection value of the voltage applied to the VCM 111. The information corresponding to the input to the actuator system 110, that is, the detection value of the voltage applied to the VCM 111 according to the first embodiment corresponds to first information.

As an operation compared with the retract operation, there is a control unloading operation. The control unloading operation is an operation of moving the magnetic head HD to the ramp load mechanism 340 under the speed control by the MPU 101. The control unloading operation is performed, for example, when the magnetic disk device 1 ends the operation.

In the control unloading operation, the speed control with high accuracy by the MPU 101 is possible, and thus less vibration occurs. However, in the control unloading operation, the MPU 101 is required to correct the offset of the circuit (a BEMF monitor circuit 408 described below) for detecting the BEMF. In addition, in the control unloading operation, the speed control by the MPU 101 is required. In the circumstance where the MPU 101 generates an error (for example, a seek error in the positioning control), it may be difficult to implement the control unloading operation that the MPU 101 intervenes. Accordingly, when the seek error occurs in the positioning control, the retract operation that does not require the control by the MPU 101 is performed, rather than the control unloading operation that requires the control by the MPU 101.

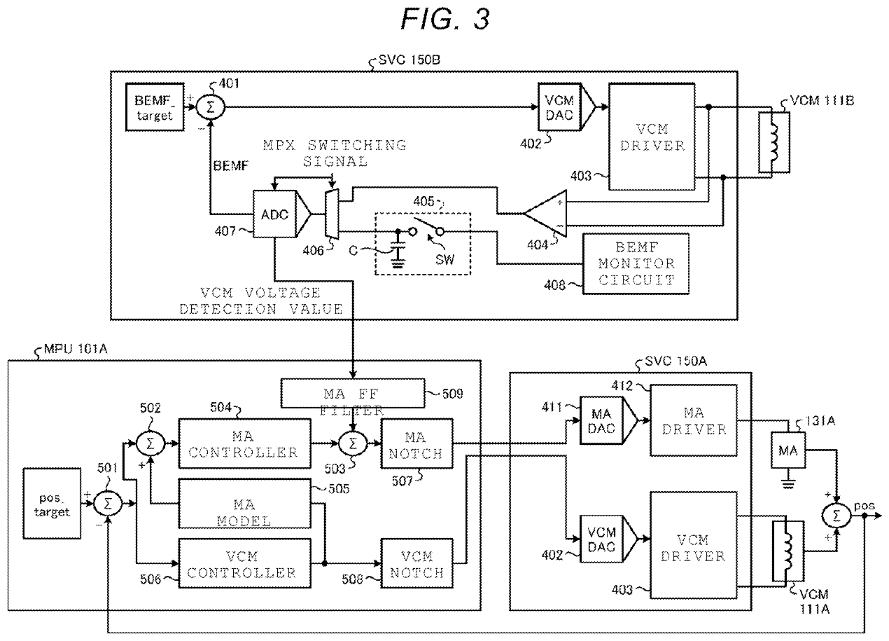

FIG. 3 is a control block diagram illustrating a retract operation of the magnetic disk device 1 related to the first embodiment. Here, the retract operation is performed in the actuator system 110B, and the positioning control of the magnetic head HD is continued in the actuator system 110A.

The SVC 150B that drives the actuator system 110B includes an adder 401, a VCM Digital-Analog Converter (DAC) 402, a VCM driver 403, an amplifier 404, a BEMF sampling circuit 405, a selector 406, an Analog-Digital Converter (ADC) 407, and the BEMF monitor circuit 408. These elements are configured with, for example, a hardware circuit.

A target value of the BEMF of the VCM 111B (BEMF_target) and the detection value of the BEMF of the VCM 111B are input to the adder 401. In addition, the BEMF corresponds to a motor speed. That is, the target value of the BEMF of the VCM 111B corresponds to the target speed value of the VCM 111B. The target value of the BEMF of the VCM 111B is stored in a predetermined position of the VCM 111B which is determined in advance.

The adder 401 subtracts the detection value of the BEMF of the VCM 111B from the target value of the BEMF of the VCM 111B. The value output from the adder 401 is input to the VCM DAC 402 as the instruction value of the drive voltage of the VCM 111B. The VCM DAC 402 converts the input value into an analog value and inputs the value converted into the analog value to the VCM driver 403. The VCM driver 403 applies the voltage in a value in accordance with the input value to the VCM 111B.

In the example, the value output from the adder 401 is input to the VCM DAC 402 without change. The value output from the adder 401 may be input to the VCM DAC 402 via any one or more filters including a filter for multiplying a gain.

The value of the voltage output by the VCM driver 403 is amplified by the amplifier 404, and is input to one of two input terminals in the selector 406.

The BEMF monitor circuit 408 detects the BEMF of the VCM 111B. The detection value of the BEMF of the VCM 111B output from the BEMF monitor circuit 408 is input to the BEMF sampling circuit 405.

The BEMF sampling circuit 405 includes a switch SW and a capacitor C of which one side is grounded. When an MPX switching signal input to the selector 406 indicates “Input 1”, it is considered as a non-conductive state, the switch SW cuts off the output of the detection value of the BEMF of the VCM 111B input from the BEMF monitor circuit 408. When the MPX switching signal indicates “Input 2”, it is considered as a conductive state, the switch SW inputs the detection value of the BEMF of the VCM 111B input from the BEMF monitor circuit 408 to the other one of the two input terminals in the selector 406.

The MPX switching signal corresponds to a state in which ON and OFF states of the drive voltage of the VCM 111 are controlled. When the drive voltage of the VCM 111B transitions to an ON state (in other words, a non-zero voltage is applied to the VCM 111B), “Input 1” is selected by the MPX switching signal. When the drive voltage of the VCM 111B transitions to an OFF state (in other words, the value of the voltage applied to the VCM 111B is zero), “Input 2” is selected by the MPX switching signal.

When the MPX switching signal indicates “Input 1”, the selector 406 inputs the value input from the amplifier 404 to the ADC 407. When the MPX switching signal indicates “Input 1”, the ADC 407 converts the value output by the amplifier 404 into a digital value and the value converted into the digital value is sent to the MPU 101A.

Here, the value output by the amplifier 404 is obtained by amplifying the value of the voltage applied to the VCM 111B, and corresponds to the detection value of the voltage applied to the VCM 111B. That is, in the actuator system 110B performing the retract operation, the detection value of the voltage applied to the VCM 111B is converted into the digital value by the ADC 407 and sent to the MPU 101A.

If the MPX switching signal indicates “Input 2”, the selector 406 inputs the detection value of the BEMF input via the BEMF sampling circuit 405 to the ADC 407. When the MPX switching signal indicates “Input 2”, the ADC 407 converts the detection value of the BEMF of the VCM 111B into the digital value and inputs the detection value of the BEMF of the VCM 111B converted into the digital value to the adder 401. Accordingly, the speed control of the VCM 111B using the detection value of the BEMF of the VCM 111B as feedback input is implemented.

In the MPU 101A, in order to cause the positions of the magnetic heads HD11 to HD16 to follow the target positions pos_target, the instruction value of the drive voltage of the microactuator 131A and the instruction value of the drive voltage of the VCM 111A are calculated. As a configuration for the purpose, the MPU 101A includes adders 501, 502, and 503, a MA controller 504, a MA model 505, a VCM controller 506, a MA notch 507, a VCM notch 508, and a MA FF filter 509. The functions of the elements are implemented, for example, by the MPU 101A executing a firmware.

The target position pos_target of the magnetic head HD and the position signal pos read by the magnetic head HD are input to the adder 501. The adder 501 subtracts the position signal pos from the target position pos_target and inputs the value obtained by subtraction to the adder 502 and the VCM controller 506.

The VCM controller 506 generates the instruction value of the drive voltage of the VCM 111A based on the input value. The instruction value generated by the VCM controller 506 is a rough instruction value based on the drive characteristics of the VCM 111A. The instruction value generated by the VCM controller 506 is finely adjusted by the VCM notch 508 and sent to the SVC 150A.

The instruction value generated by the VCM controller 506 is also input to the MA model 505. The MA model 505 is a model of simulating response characteristics of the microactuator 131A. The MA model 505 calculates the response of the microactuator 131A based on the rough instruction value of the drive voltage of the VCM 111A generated by the VCM controller 506 and inputs the calculated value of the response of the microactuator 131A to the adder 502.

The adder 502 adds up the two input values and inputs the added-up values to the MA controller 504. The MA controller 504 generates the instruction value of the drive voltage of the microactuator 131A based on the input value. The instruction value generated by the MA controller 504 is a rough instruction value based on the drive characteristics of the microactuator 131A. The instruction value generated by the MA controller 504 is input to the adder 503.

The MPU 101A acquires the detection value of the voltage applied to the VCM 111B from the SVC 150B controlling the retract operation. The detection value of the voltage applied to the VCM 111B is input to the MA FF filter 509. The detection value of the voltage applied to the VCM 111 may be referred to as a VCM voltage detection value.

The MA FF filter 509 is a filter for performing feed forward control on the microactuator 131A. The MA FF filter 509 calculates an adjustment amount of the instruction value of the drive voltage of the microactuator 131A based on the detection value of the voltage applied to the VCM 111B. The adjustment amount is an amount for preventing the influence of the vibration occurring in the VCM 111B on the positioning control of the actuator system 110B. The MA FF filter 509 inputs the calculation value of the adjustment amount to the adder 503.

The adder 503 adds or subtracts the adjustment amount calculated by the MA FF filter 509 to and from the instruction value generated by the MA controller 504 to adjust the instruction value generated by the MA controller 504. In addition, whether the adder 503 adds or subtracts the adjustment amount is set according to the setting of the reference numeral of the adjustment amount.

The instruction value of the drive voltage of the MA controller 504 output from the adder 503 is finely adjusted by the MA notch 507 and sent to the SVC 150A.

The SVC 150A includes a MA DAC 411 and a MA driver 412 in addition to the VCM DAC 402 and the VCM driver 403. These elements are configured, for example, by a hardware circuit.

The VCM DAC 402 converts the instruction value of the drive voltage of the VCM 111A input from the MPU 101A into an analog value and inputs the value converted into the analog value to the VCM driver 403. The VCM driver 403 applies the voltage of the size in accordance with the input value to the VCM 111A.

The MA DAC 411 converts the instruction value of the drive voltage of the microactuator 131 input from the MPU 101A into an analog value and inputs the value converted into the analog value to the MA driver 412. The MA driver 412 applies the voltage of the size in accordance with the input value to the microactuator 131A.

By the application of drive voltage to the VCM 111A and the microactuator 131A, the actuator system 110A moves the magnetic head HD. The magnetic head HD reads the position signal pos from the magnetic disk 300 at the current position, and the position signal pos is input to the adder 501 of the MPU 101A.

The MPU 101A calculates the instruction value of the drive voltage of the VCM 111A and the instruction value of the drive voltage of the microactuator 131A by using the input position signal pos as the feedback input. That is, the MPU 101A can perform the positioning control of the magnetic head HD by using the position signal pos as the feedback input.

When the retract operation is performed in the actuator system 110B, the MPU 101A uses the detection value of the drive voltage of the VCM 111B in the positioning control of the magnetic head HD as the feed forward input to prevent the influence of the vibration on the positioning control.

Accordingly, even if the vibration occurring in the VCM 111B during the retract operation propagates to the actuator system 110A performing the positioning control, the deterioration of the positioning accuracy in the actuator system 110A caused by the vibration can be prevented.

FIG. 3 illustrates a control block when the retract operation is performed in the actuator system 110B, and the positioning control of the magnetic head HD is performed in the actuator system 110A. When the retract operation is performed in the actuator system 110A, and the positioning control of the magnetic head HD is performed in the actuator system 110B, the SVC 150A controls the retract operation of the actuator system 110A and also transmits the detection value of the drive voltage of the VCM 111A to the MPU 101B according to the same configuration as the SVC 150B illustrated in FIG. 3. In the MPU 101B, according to the same configuration as the MPU 101A illustrated in FIG. 3, in the positioning control of the magnetic head HD, the detection value of the drive voltage of the VCM 111A of the actuator system 110A is used as the feed forward input. Accordingly, even if the vibration occurring in the VCM 111A during the retract operation propagates to the actuator system 110B performing the positioning control, the deterioration of the positioning accuracy in the actuator system 110B caused by the vibration can be prevented.

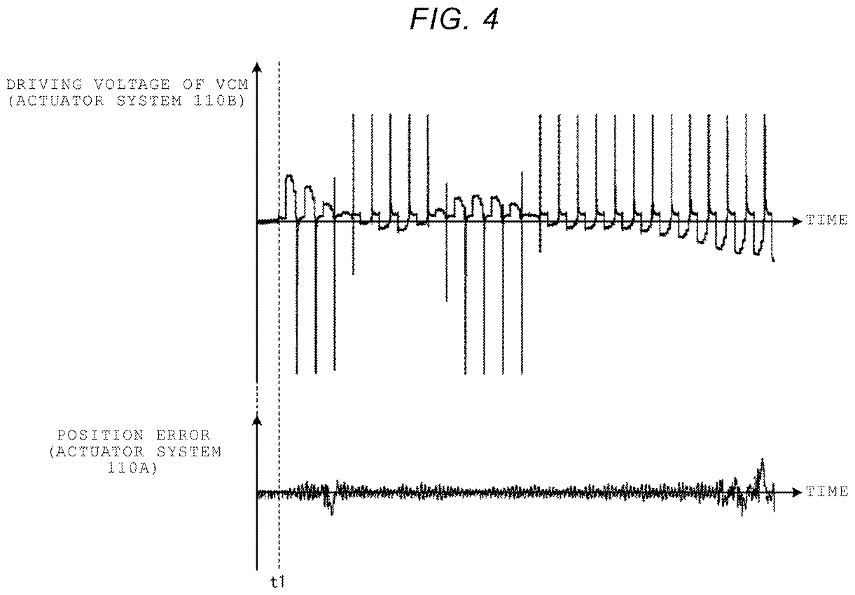

FIG. 4 is a schematic diagram illustrating an example of a relationship between a drive voltage applied to the VCM 111B in the actuator system 110B and a position error of the magnetic head HD under the positioning control by the actuator system 110A in the magnetic disk device 1 related to the first embodiment. The waveform illustrated in the upper portion of this figure shows a temporal change of the detection value of the drive voltage applied to the VCM 111B. The waveform illustrated in the lower portion of this figure shows a temporal change of the position error of the magnetic head HD under the positioning control using the actuator system 110A.

At time t1, the retract operation starts in the actuator system 110B. Then, the detection value of the drive voltage applied to the VCM 111B starts to change in a substantially rectangular wave shape including many sharp peaks based on the resonance frequency. It can be read that although the position error of the magnetic head HD under the positioning control by the actuator system 110A gradually increases from the time t1, the position error does not diverge to a predetermined level or more.

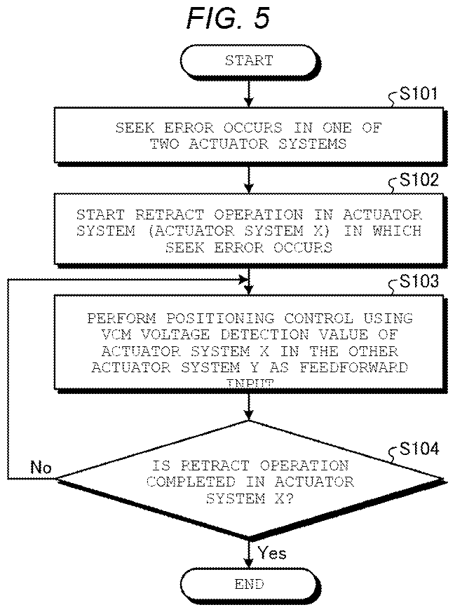

FIG. 5 is a flowchart illustrating an example of an operation of the magnetic disk device 1 related to the first embodiment. In addition, it is considered that the operation illustrated in this figure starts in a state where positioning control is performed in both of the two actuator systems 110.

First, in any one of the two actuator systems 110, if a seek error occurs (S101), the MPU 101 among the two MPUs 101 which corresponds to the actuator system 110 (an actuator system X is denoted) in which a seek error occurs instructs the SVC 150 among the two SVCs 150 that drives the actuator system X to start the retract operation. Accordingly, the retract operation starts in the actuator system X (S102).

Then, the MPU 101 that controls the other actuator system (an actuator system Y is denoted) uses the VCM voltage detection value in the actuator system X as the feed forward input in the positioning control of the magnetic head HD (S103). The operation of S103 continues during the period when the retract operation is performed in the actuator system X (No in S104). If the retract operation is completed in the actuator system X (Yes in S104), a series of operations are completed.

In addition, the actuator system X among the two actuator systems 110 in which a seek error occurs is an example of the first actuator system. The other actuator system Y among the two actuator systems 110 is an example of the second actuator system.

In addition, the SVC 150 that drives the first actuator system and the MPU 101 that controls the first actuator system are examples of the first controller. The SVC 150 that drives the second actuator system and the MPU 101 that controls the second actuator system are examples of the second controller.

In addition, the SVC 150 that drives the first actuator system is an example of the first servo controller. In addition, the MPU 101 that controls the first actuator system is an example of the first processor.

As described above, according to the first embodiment, while the first controller (the SVC 150B in the example illustrated in FIG. 3) controls the retract operation, the second controllers (the MPU 101A and the SVC 150A in the example illustrated in FIG. 3) uses the first information (the detection value of the drive voltage of the VCM 111B in the example illustrated in FIG. 3) corresponding to the input (the drive voltage of the VCM 111B in the example illustrated in FIG. 3) to the first actuator system as the feed forward input to perform the positioning control of the magnetic head HD.

Accordingly, even if the vibration occurring in the VCM 111 in the actuator system during the retract operation propagates to the other actuator system 110 performing the positioning control, the deterioration of the positioning accuracy of the other actuator system 110 caused by the vibration can be prevented.

In addition, the first controller includes a first servo controller that drives the first actuator system (for example, the SVC 150) and a first processor (for example, the MPU 101) that performs the positioning control of the magnetic head HD by inputting the second information (for example, the instruction value of the drive voltage of the microactuator 131 and the instruction value of the drive voltage of the VCM 111) based on the position signal pos read by the magnetic head HD to the first servo controller. When a seek error occurs in the positioning control by the first processor, the first servo controller controls the retract operation.

The error occurring in the first processor is not limited to the seek error, and the magnetic disk device 1 may be configured so that the first servo controller starts the retract operation when any errors occur.

### Second Embodiment

In the first embodiment, the detection value of the drive voltage of the VCM 111 is used as the feed forward input in the positioning control. The information used as the feed forward input is not particularly limited.

In a second embodiment, a configuration in which the instruction value of the drive voltage of the VCM 111 is used as the feed forward input is described. In addition, in the second embodiment, the same configuration as that of the first embodiment is not described.

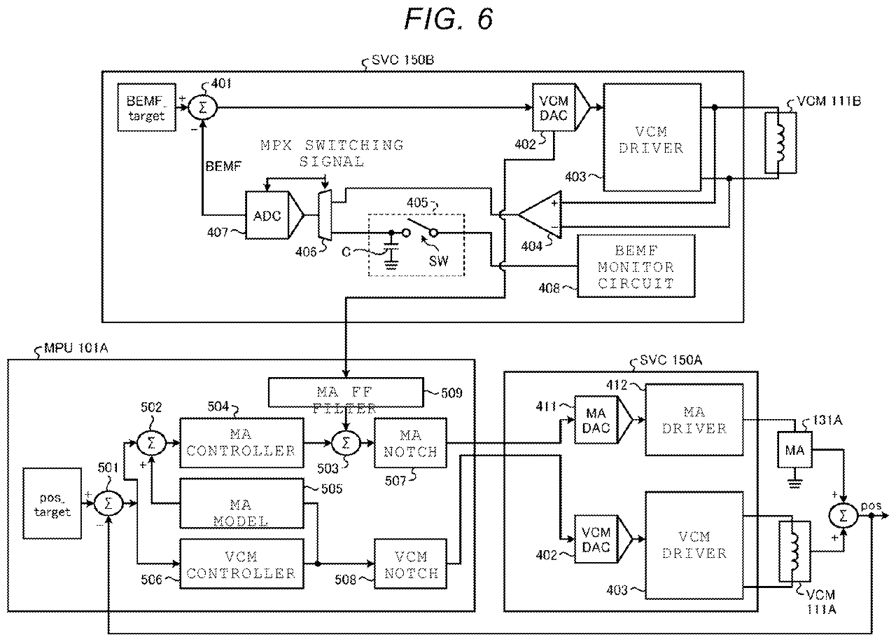

FIG. 6 is a control block diagram illustrating the retract operation of the magnetic disk device 1 related to the second embodiment. In addition, similarly to the case of FIG. 3, it is considered that the retract operation is performed in the actuator system 110B, and the positioning control of the magnetic head HD continues in the actuator system 110A.

As illustrated in FIG. 6, the instruction value input to the VCM driver 403 that is generated in the SVC 150B while the retract operation is controlled, that is, the instruction value of the drive voltage of the VCM 111B is input from the VCM DAC 402 to the MA FF filter 509 in the MPU 101B performing the positioning control. The MA FF filter 509 calculates the adjustment amount based on the input instruction value.

Accordingly, even if the vibration occurring in the VCM 111B during the retract operation propagates to the actuator system 110A performing the positioning control, and the deterioration of the positioning accuracy in the actuator system 110A caused by the vibration can be prevented.

In addition, FIG. 6 illustrates a control block when the retract operation is performed in the actuator system 110B, and the positioning control of the magnetic head HD is performed in the actuator system 110A. When the retract operation is performed in the actuator system 110A, and the positioning control of the magnetic head HD is performed in the actuator system 110B, the SVC 150A, according to the same configuration as the SVC 150B illustrated in FIG. 6 controls the retract operation of the actuator system 110A and transmits the instruction value of the drive voltage of the VCM 111A to the MPU 101B. In the MPU 101B, according to the same configuration as the MPU 101A illustrated in FIG. 6, in the positioning control of the magnetic head HD, the instruction value of the drive voltage of the VCM 111A of the actuator system 110A is used as the feed forward input. Accordingly, even if the vibration occurring in the VCM 111A during the retract operation propagates to the actuator system 110B performing the positioning control, deterioration of the positioning accuracy in the actuator system 110B caused by the vibration can be prevented.

### Third Embodiment

In the first and second embodiments, the information of the drive voltage of the VCM 111 in the actuator system 110 during the retract operation is used as the feed forward input in the control of the microactuator 131 in the actuator system 110 during the positioning control. The information of the drive voltage of the VCM 111 in the actuator system 110 during the retract operation may be used as the feed forward input in the control of the VCM 111 in the actuator system 110 during the positioning control.

In a third embodiment, a case where the information of the drive voltage of the VCM 111 in the actuator system 110 during the retract operation is used as the feed forward input in both of the control of the microactuator 131 and the control of the VCM 111 in the actuator system 110 during the positioning control. In the third embodiment, the same configuration as that of the first embodiment is not described.

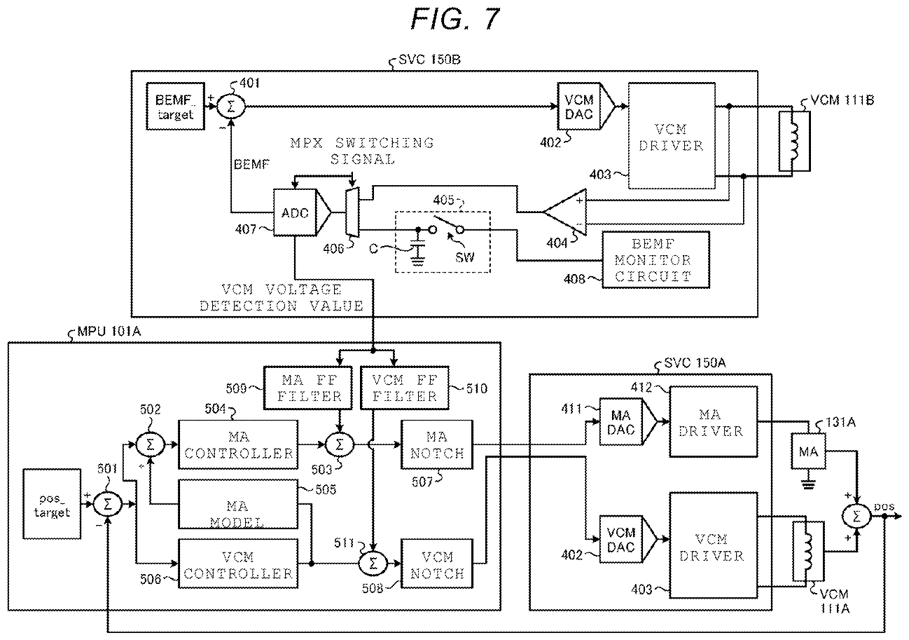

FIG. 7 is a control block diagram illustrating a retract operation of the magnetic disk device 1 related to the third embodiment. Here, similarly to the case of FIG. 3, the retract operation is performed in the actuator system 110B, and the positioning control of the magnetic head HD continues in the actuator system 110A.

As illustrated in FIG. 7, the MPU 101A performing the positioning control includes a VCM FF filter 510 and an adder 511 in addition to the configuration illustrated in FIG. 3.

The VCM FF filter 510 is a filter for performing the feed forward control on the VCM 111A. The VCM FF filter 510 calculates the adjustment amount of the instruction value of the drive voltage of the VCM 111A based on the detection value of the voltage applied to the VCM 111B. The VCM FF filter 510 inputs the calculated value of the adjustment amount to the adder 511.

The instruction value generated by the VCM controller 506 is input to the adder 511, in addition to the calculated value of the adjustment amount. The adder 511 adds or subtracts the adjustment amount calculated by the VCM FF filter 510 to and from the instruction value generated by the VCM controller 506 to adjust the instruction value generated by the VCM controller 506. In addition, whether the adder 511 adds or subtracts the adjustment amount is set according to the setting of the reference numeral of the adjustment amount.

The instruction value of the drive voltage of the VCM 111A output from the adder 511 is finely adjusted by the VCM notch 508 and sent to the SVC 150A.

In this manner, in the example illustrated in FIG. 7, during the retract operation in the actuator system 110B, in the actuator system 110A during the positioning control, the detection value of the drive voltage of the VCM 111B is used as the feed forward input, and the microactuator 131A and the VCM 111A are controlled.

Accordingly, even if the vibration occurring in the VCM 111B during the retract operation propagates to the actuator system 110A performing the positioning control, the deterioration of the positioning accuracy in the actuator system 110A caused by the vibration can be prevented.

In addition, FIG. 7 illustrates a control block when the retract operation in the actuator system 110B is performed, and the positioning control of the magnetic head HD is performed in the actuator system 110A. When the retract operation is performed in the actuator system 110A, and the positioning control of the magnetic head HD is performed in the actuator system 110B, the SVC 150A controls the retract operation of the actuator system 110A and transmits the detection value of the drive voltage of the VCM 111A to the MPU 101B, according to the same configuration as the SVC 150B illustrated in FIG. 7. According to the same configuration as the MPU 101A illustrated in FIG. 7, in the MPU 101B, the detection value of the drive voltage of the VCM 111A of the actuator system 110A is used as the feed forward input in the positioning control of the magnetic head HD. Accordingly, even if the vibration occurring in the VCM 111A during the retract operation propagates to the actuator system 110B performing the positioning control, the deterioration of the positioning accuracy in the actuator system 110B caused by the vibration can be prevented.

### Fourth Embodiment

In a fourth embodiment, a configuration in which the instruction value of the drive voltage of the VCM 111 is used as the feed forward input is described. In addition, in the fourth embodiment, the same configuration as that of the third embodiment is not described.

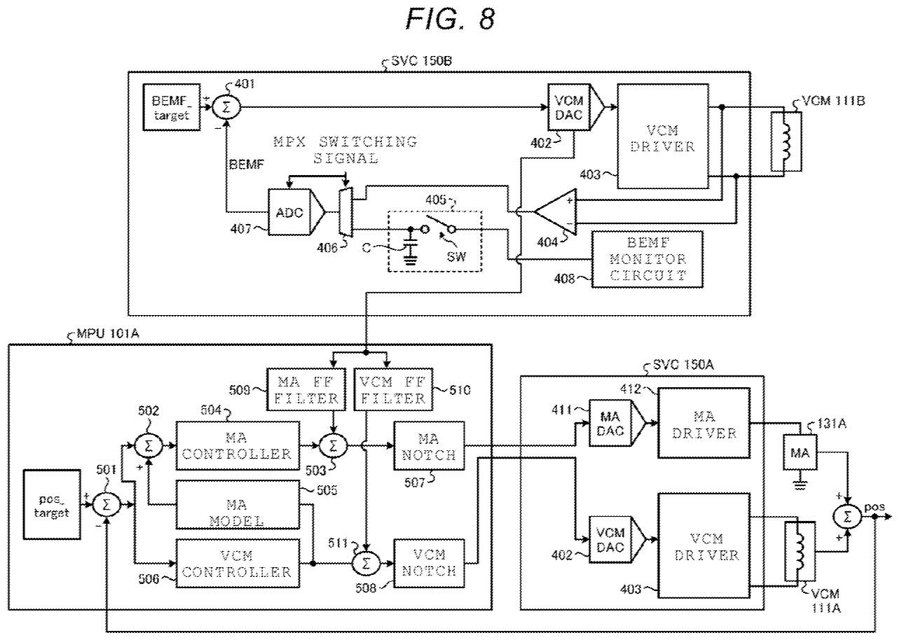

FIG. 8 is a control block diagram illustrating a retract operation of the magnetic disk device 1 related to the fourth embodiment. In addition, here, similarly to the case of FIG. 3, the retract operation is performed in the actuator system 110B, and the positioning control of the magnetic head HD continues in the actuator system 110A.

As illustrated in FIG. 8, the instruction value input to the VCM driver 403 in the SVC 150B controlling the retract operation, that is, the instruction value of the drive voltage of the VCM 111B is input from the VCM DAC 402 of the SVC 150B to the MA FF filter 509 and the VCM FF filter 510 in the MPU 101B performing the positioning control. The MA FF filter 509 calculates the adjustment amount based on the input instruction value. The VCM FF filter 510 calculates the adjustment amount based on the input instruction value.

Accordingly, even if the vibration occurring in the VCM 111B during the retract operation propagates to the actuator system 110A performing the positioning control, the deterioration of the positioning accuracy in the actuator system 110A caused by the vibration can be prevented.

In addition, FIG. 8 illustrates a control block when the retract operation is performed in the actuator system 110B, and the positioning control of the magnetic head HD is performed in the actuator system 110A. When the retract operation is performed in the actuator system 110A, and the positioning control of the magnetic head HD is performed in the actuator system 110B, the SVC 150A controls the retract operation of the actuator system 110A and transmits the instruction value of the drive voltage of the VCM 111A to the MPU 101B according to the same configuration as the SVC 150B illustrated in FIG. 8. According to the same configuration as the MPU 101A illustrated in FIG. 8, in the MPU 101B, the instruction value of the drive voltage of the VCM 111A of the actuator system 110A is used as the feed forward input in the positioning control of the magnetic head HD. Accordingly, even if the vibration occurring in the VCM 111A during the retract operation propagates to the actuator system 110B performing the positioning control, the deterioration of the positioning accuracy in the actuator system 110B caused by the vibration can be prevented.

In the first and second embodiments, the information of the drive voltage of the VCM 111 in the actuator system 110 during the retract operation is used as the feed forward input only in the control of the microactuator 131 in the actuator system 110 during the positioning control. In addition, in the third and fourth embodiments, the information of the drive voltage of the VCM 111 in the actuator system 110 during the retract operation is used as the feed forward input in both of the control of the microactuator 131 and the control of the VCM 111 in the actuator system 110 during the positioning control.

The magnetic disk device 1 may be configured so that the information of the drive voltage of the VCM 111 in the actuator system 110 during the retract operation is used as the feed forward input only in the control of the VCM 111 in the actuator system 110 during the positioning control.

According to the first to fourth embodiments, the information of the drive voltage of the VCM 111 in the actuator system 110 during the retract operation is used as the feedback input in the positioning control of the magnetic head of the other actuator system 110. The method of using the information of the drive voltage of the VCM 111 in the actuator system 110 during the retract operation in the positioning control of the magnetic head of the other actuator system 110 is not limited to the method of using the information as the feedback input. The information of the drive voltage of the VCM 111 in the actuator system 110 during the retract operation may be used as the feedback input in the positioning control of the magnetic head of the other actuator system 110.

As described above, according to the first to fourth embodiments, while the magnetic head of the first actuator system is retracted, the second controller acquires the information corresponding to the input to the first actuator system and performs the positioning control using the information.

Accordingly, even if the vibration occurring in the VCM 111 in the actuator system 110 during the retract operation propagates to the other actuator system 110 performing the positioning control, the deterioration of the positioning accuracy in the other actuator system 110 caused by the vibration can be prevented. That is, the influence of the vibration occurring during the retract operation can be prevented as much as possible.

The configurations described above may be applied to a magnetic disk device with three or more actuator systems. For example, at least two of the three or more actuator systems may function as a pair of the first actuator system of the embodiment and the second actuator system of the embodiment.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure. Further, although several embodiments are delineated (e.g., First Embodiment, Second Embodiment, etc.), it should be understood that while certain aspects may be mutually exclusive, others may not, and certain aspects of each embodiment may be combined to form additional embodiments.

What is claimed is:

1. A magnetic disk device comprising:
a magnetic disk;
a first magnetic head and a second magnetic head that record data and reproduce data with respect to the magnetic disk;
a first actuator system provided with the first magnetic head;
a second actuator system provided with the second magnetic head;
a first controller that controls the first actuator system and moves the first magnetic head relative to the magnetic disk; and
a second controller that controls the second actuator system and moves the second magnetic head relative to the magnetic disk,
wherein, while the first magnetic head is retracted, the second controller acquires first information corresponding to input to the first actuator system and uses the first information to control a position of the second magnetic head.

2. The magnetic disk device of claim 1, wherein the second controller uses the first information as feed forward input to control the position of the second magnetic head.

3. The magnetic disk device of claim 1,
wherein the first controller comprises:
a first servo controller that drives the first actuator system, and
a first processor that inputs second information based at least in part on a position signal read by the first magnetic head to the first servo controller and controls the position of the first magnetic head, and
wherein, when an error occurs with controlling the position by the first processor, the first servo controller controls retraction of the first magnetic head.

4. The magnetic disk device of claim 1, wherein the first actuator system comprises a first voice coil motor, and the input to the first actuator system is a voltage applied to the first voice coil motor, and the first information is a detection value of the voltage.

5. The magnetic disk device of claim 3,
wherein the first actuator system comprises a first voice coil motor, and the input to the first actuator system is a voltage applied to the first voice coil motor, and
wherein the first servo controller comprises a first driver that applies a voltage in accordance with an instruction value to the first voice coil motor, and the first information is the instruction value.

6. The magnetic disk device of claim 1,
wherein the second actuator system comprises
an actuator arm,
a second voice coil motor that is provided at one end of the actuator arm and rotatably moves the actuator arm,
a support member that is connected to the other end of the actuator arm and supports the second magnetic head, and
an actuator element that is provided in a connection portion between the actuator arm and the support member and moves the support member, and
wherein the second controller uses the first information as the feed forward input and controls the actuator element.

7. The magnetic disk device of claim 1,
wherein the second actuator system comprises:
an actuator arm,
a second voice coil motor that is provided at one end of the actuator arm and rotatably moves the actuator arm,
a support member that is connected to the other end of the actuator arm and supports the second magnetic head, and
an actuator element that is provided in a connection portion between the actuator arm and the support member and moves the support member, and
wherein the second controller uses the first information as feed forward input and controls the second voice coil motor.

8. A magnetic disk device comprising:
at least two magnetic disks;
at least two actuator systems, each of which includes a magnetic head which records data to the magnetic disk; and
a processor configured to control the actuator system;
wherein, when one of the magnetic head is retracted, the processor controls a position of another magnetic head which is different from retracted magnetic head based at least in part on an information corresponding to an input from the actuator system comprising retracted magnetic head.

9. The magnetic disk device of claim 8, wherein the processor uses the information as feed forward input to control the position of the magnetic head.

10. A method of controlling a magnetic disk device comprising a magnetic disk, a first magnetic head and a second magnetic head that records data and reproduces data with respect to the magnetic disk, a first actuator system that is provided with the first magnetic head, and a second actuator system provided with the second magnetic head, the method comprising:
retracting the first magnetic head; and
while the first magnetic head is retracted, using first information corresponding to input to the first actuator system to control a position of the second magnetic head.
